(19) United States
(12) Patent Application Publication
(10) Pub. No.: US 2018/0300686 A1
(43) Pub. Date: Oct. 18, 2018

(54) RECRUITING SERVICE MODULAR TABLE INTERFACE

(71) Applicant: Daniel Zia Joseph, San Diego, CA (US)

(72) Inventor: Daniel Zia Joseph, San Diego, CA (US)

(21) Appl. No.: 15/487,412

(22) Filed: Apr. 13, 2017

(51) Int. Cl. G06Q 10/10; G06F 17/30

(52) U.S. Cl. CPC G06Q 10/1053; G06F 17/30707; G06F 17/30713

(57) ABSTRACT

A recruiting service is presented that profiles data scientists per specific skills and application based on years of experience. A modular table interface is designed to allow for job-relevant skills to be mixed and matched per industry. Conserved skillset tables contain cross-disciplinary technical skills that are universally desired among data scientists of any industry as these skills function agnostically to the data source whereas variable skillset tables contain technical skills pertinent only within a specific industry and are thereby interchangeable. Conserved skillset tables contain software and machine learning skills and applications.

### FIELD OF THE INVENTION

The present invention is created to assist in classifying, profiling, and recruiting data scientists by utilizing high specificity profiling parameters with which to classify these experts. Classification methodologies involve a modular table-based user interface to organize information aiding in recruiting data scientists. Tables are designed to be interchangeable and elastic. Tabled skillsets classifying data scientists may be queried by a search protocol to filter for desired candidates.

### BACKGROUND OF THE INVENTION

Data science is a low-resolution term encompassing a widening array of software based experts. Recruiting said individuals is difficult due to the esoteric nomenclature involved in describing their skills and techniques. Differentiation of these data scientists is impossible without an in depth understanding of their skills. Many variations of data science experts are blurred together causing confusion during hiring processes and talent acquisition.

Many data science skills are agnostic to the type of data being analyzed and are therefore universally desired among all data science experts while other data science skills fundamentally depend on where the data is sourced from (i.e. Genetic data, financial data, aerospace data, etc.).

One of the problems in the prior art is a lack of consideration for data science skillset organization on a per industry basis that differentiates between the cross-disciplinary skills universally desired in all industries versus industry specific skillsets. Certain skills must be discriminately isolated and grouped together in meaningful ways to assist hiring managers in associating project compatibility with each data scientist. Prior art focuses mainly on displaying commonly desired software skills but maintains a low-resolution visualization of data scientists by not including an interface for further insight into industry specific data science skillsets.

Prior art does not provide a logical visual interface displaying universally applicable data science skills in contrast to skills which are required specifically per industry and are therefore interchangeable depending on industry. This makes it difficult for data scientists to differentiate themselves especially if they have experience across multiple industries and therefore require varying representations of their skills and experience.

### SUMMARY OF THE INVENTION

Data science professionals voluntarily input their number of years of experience for hundreds of technical skills and relevant applications provided by the recruiting service. The graphical user interface organizes profile information into segregated modular tables organized according to the inventor's acquired knowledge of key industry skillsets and the relationships between these skillsets. Specific skillset tables are kept consistent among all data scientist profiles regardless of industry (conserved tables) while designated industry-dependent skillset tables are interchangeably replaced in each profile per industry (variable tables).

Hiring managers are provided a search protocol in which they may input one or more skills to fitter out data scientist profiles lacking said skills necessary for a job. As each skill is inputted the user profiles are filtered in real time to provide visual confirmation of filtration. Thus, following input of desired skills, the remaining profiles correspond with viable data scientist candidates for a particular job.

### BRIEF DESCRIPTION OF THE DRAWINGS

FIG. 1 is a basic overview of a recruiting service for data scientists.

FIG. 2 displays the search protocol along with a list of profiles resulting from query input pertaining to desired skills.

FIG. 3 displays an individual profile containing tables listing technical skills.

FIG. 4 illustrates the modular table operational design which statically displays conserved skills while offering interchangeability for variable skills.

### DETAILED DESCRIPTION

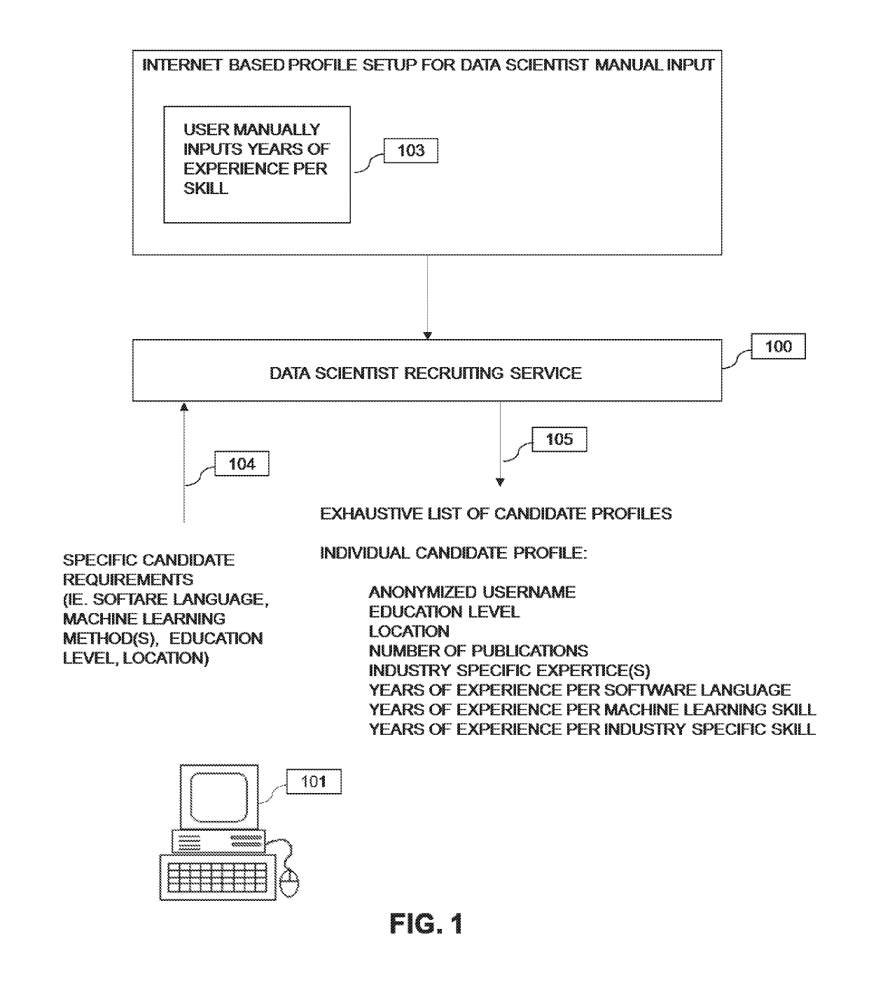

FIG. 1 shows an overview of how recruiting service 100 functions. This invention is a computer-based service involving servers and required hardware, including but not limited to computer processing units, a database, and memory containing software programming commands. The recruiting service 100 utilizes internet connectivity to allow users the ability to manually input their profile information including contact information, skills, location, and industry specific focus.

A profile setup page 103 is offered to new users accessing the internet domain housing recruiting service and allows them to manually input information necessary to set up a new profile which involves years of experience per technical skill. This manually inputted information is then saved on a computer server with a database designed to organize and store it. Upon generation of a new profile each user will receive a randomized serial number that will serve as the sole identifying name for their profile. Hence, all profiles are completely anonymous to ensure privacy protection and confidentiality for each member. This is necessary to prevent unwanted solicitation from outside recruiters and human resources professionals.

Anyone with access to the internet can access 104 the website domain housing the recruiting service and view all profiles that have been created. A search protocol is designed and made available for anyone to utilize which will filter the entire database of candidates based on desired skills or other parameters.

Adjacent to the search tool is a list of all profiles 105 displayed as cards housing select preview information per each candidate such as identifying serial number, location, education level, number of publications, and career focus. Initially all profiles are listed exhaustively and as specific skills are selected via search protocol only relevant candidate profiles remain on the page while other profiles are filtered out in real-time response to user's search input.

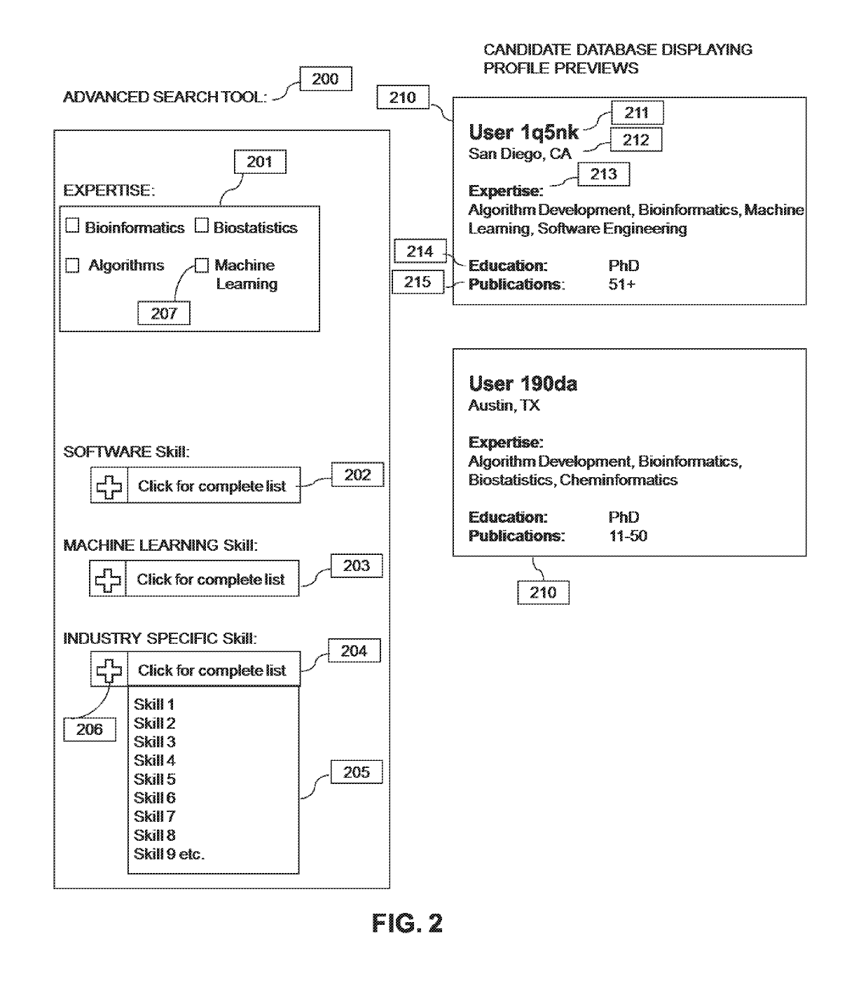

FIG. 2 explains the search tool 200 in detail. Search tool is accessed by visiting the website domain housing recruiting service and clicking a hyperlink embedded button offering access to the search function. The functionality of search tool is based on manual user input which then accesses the database housing all candidate information to execute lines of software programming which result in the visual display of only those candidate profile preview cards 210 containing the selected search parameters.

Candidate profiles are displayed adjacent to search tool as an exhaustive list of cards 210 containing select profile information as a preview. The profile preview information involved contains the candidates identifying serial number 211, the candidate's location 212 the candidates expertise 213 which operates as their industry specific focus, the candidates education level 214, and their number of publications 216. As a user of the search tool selects specific skills they desire in a candidate the profile cards are immediately filtered to display only candidates with said skills.

The search tool 200 contains several separate input mechanisms made available by user interface design implementing check boxes as well as drop down lists containing every variable associated with user profiles that may be manually selected. Altogether there are hundreds of parameters which may be manually selected to filter through candidate profiles. Expertise 201 contains industry specific focuses which candidates may select one or more of. In the figure provided the list of expertise involves the biotechnology industry. However, these expertise parameters can be exchanged for different sets depending on which industry is desired. Each individual expertise displayed is associated with a check box which the user may choose to toggle. Once the check box is toggled a visual confirmation is provided by color change within the check box and the candidate profiles are filtered to display only those containing the selected expertise. User may select as many or as few expertise variables as desired.

Drop down lists display all technical skills possibly associated with candidate profiles including software skills 202, machine learning skills 203, and industry specific technical skills 204. An example of the displayed drop down list 205 demonstrates the user interface design implemented in recruiting service. Each drop down list possess an associated addition button 206 allowing additional skills to be added. Upon each subsequent skill added the profiles are further filtered down to remove any profiles not containing selected skills.

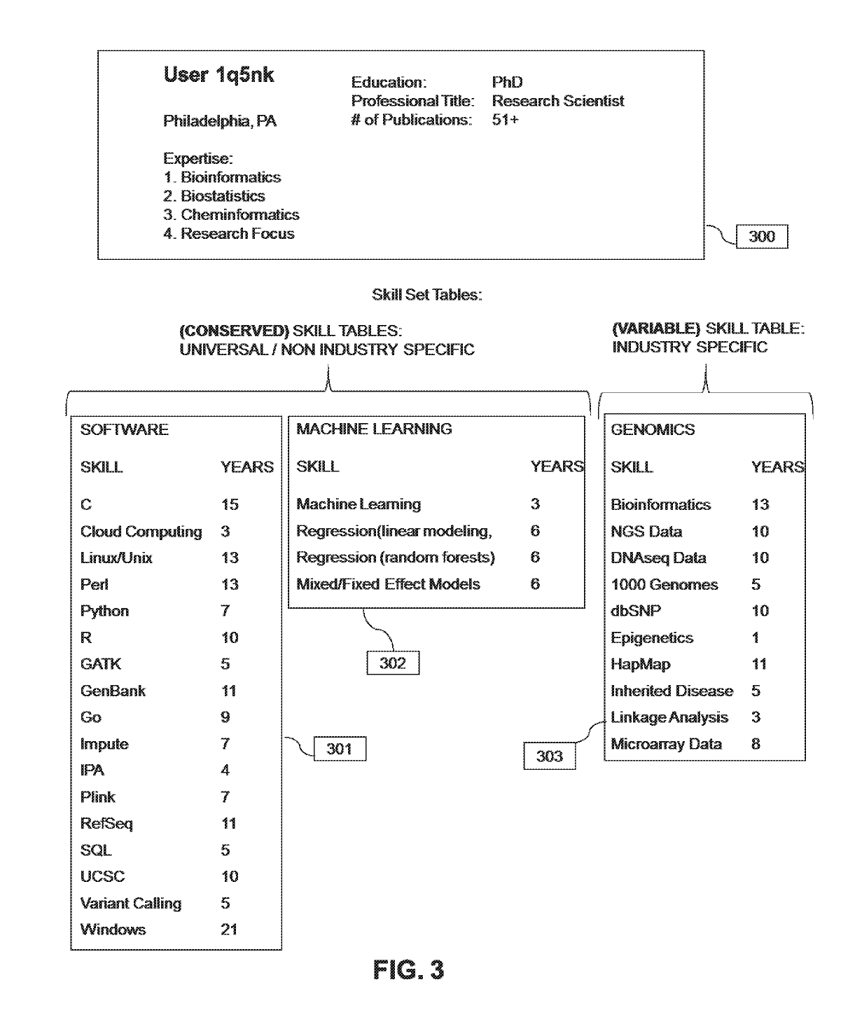

FIG. 3 displays the user interface design for a fully accessed candidate profile. The candidates profile page contains a header portion 300 involving their identifying information. The footer portion of the page contains technical their technical skills organized as lists in separate tables. These skills are manually inputted by each candidate either upon creating their profiles or upon later access to their accounts at which time they may choose to edit, add, or remove their profile information.

It is the technical skill set tables displayed here which allows this invention unique quality and execution. By design, there are skill set tables which universally define any data scientist regardless of which industry they are working in. The reason for this is that certain software skills and methodologies are cross-disciplinary and agnostic to data sources. These skills function to execute data science tasks within any and all industries. The determination of which skills are universal among industries relies upon an intimate understanding of data science both holistically and within individual industries. This information is gathered by interviewing hundreds of data science candidates across as many industries as possible. Harnessing such knowledge allows for the creative and unique design underlying the invention.

Separate tables in FIG. 3 contain software skills 301 and machine learning skills 302 which are utilized universally in data science across all disciplines or industries. These tables are known as conserved skill tables designated as such in that they remain static and relevant among all user profiles.

In contrast to the conserved skill tables is a variable skill table 303 which in this specific example pertains to the genomics/biotechnology industry. This list contains skills, research methodologies, and applications relevant to this specific industry from which genetic data is sourced. Any data science candidate viable for work in this industry must therefore possess experience within the specific skills listed.

A key aspect of the variable table is that it is wholly interchangeable between user profiles based on the industry being queried. This variable table with all its skillsets may be swapped out for entirely different variable tables whereas the conserved tables will not change.

The unique functionality of invention is this: recruiting service represents data science candidates for any industry in an organized, high-resolution, and logical fashion by way of conserved skill tables 301, 302 in contrast with variable skill tables 303. Conserved skills are inclusive of all data scientists in contrast with variable skills which pertain only to data scientists within a specific industry or field. Simply by swapping out the variable table 303 with industry-specific technical skills the recruiting service consistently applies high-resolution candidate profiling for any given industry.

An example of this would be having an exhaustive list of data science candidate profiles initially numbering 1000 but then filtering all these candidates down to <100 per industry by toggling industry specific variable skills from genetics to: aerospace, financial, electrical engineering, physics, geospatial data, chemistry, etc. During this toggling process software skills 301 and machine learning skills 302 remain static while the variable table 303 is interchanged with new skillsets relevant per industry.

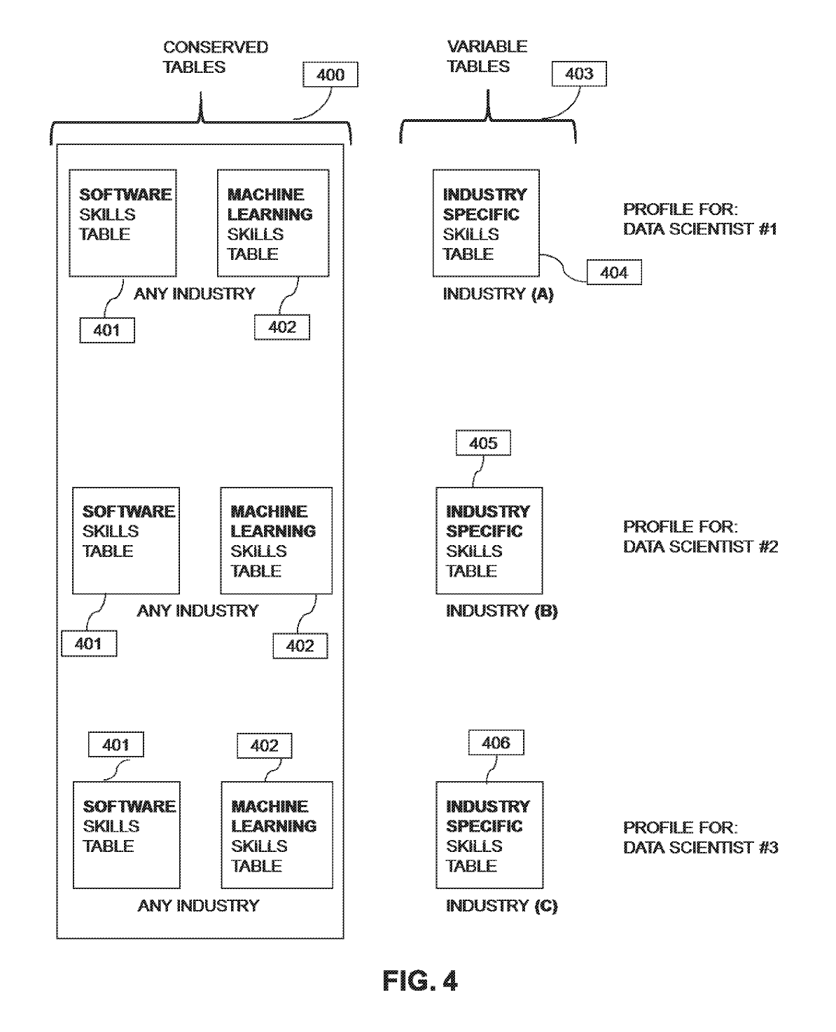

FIG. 4 simplifies the concept and operation behind the conserved skillset table 400 vs variable skillset table 403 function. Software skills 401 and machine learning skills 402 are universally desired in data scientist candidates among all industries. These skills are cross-disciplinary being that they execute computational functions agnostic to the data source. However, within each individual industry are skillsets that do in fact rely upon the specificity of data sources and are therefore very specific to that industry. Variable tables 403 list these industry specific skills and will need to be exchanged depending on which data scientist candidate is being queried. A given data scientist's specific skills for industry (A) 404 will differ from those of a data scientists in industry (B) 405 or industry (C) 406 hence making these skills exclusive to their respective industries.

By keeping some tables conserved and others variable the recruiting service allows users to rely on consistent representation of data scientists for any number of career focuses as their organization may wish to engage several different types.

Also, data scientists who indeed have worked in several industries may choose to display multiple variable tables simultaneously along with their foundationally applicable conserved skillset tables.

What is claimed is:

1. A computer implemented method of organizing information for classifying, differentiating, and recruiting cross-disciplinary data scientists executed on a computer having a processor, a memory and a network interface, consisting of:
Receiving in the processor by way of the network interface the manual input from data scientists regarding their number of years of experience pertaining to technical skills which are listed on the user interface.
Generating in the processor individual profiles for each data scientist voluntarily opting to join the network
Receiving, in the processor a query specifying technical skills to a network member
Generating, in the processor, a graphical user interface that displays to the user in response to the query, the graphical user interface including profiles of individual software developers fulfilling the query,

2. The method of claim 1, further consisting of an organizational method of isolating into predetermined lists specific skills associated with a data scientist's number of years of experience.

3. The method of claim 2, wherein a profile of individual data scientists includes a display of the lists including each skill name and the number of years of experience the user professes to maintain.

4. The method of claim 2, wherein certain lists remain universally displayed among all individual profiles while other lists are replaced depending on the industry being queried via the graphical user interface search protocol.

5. The method of claim 2, where in the universally displayed lists contain software programming skills and applications as well as machine learning methodologies.

6. The method of claim 2, wherein the replaceable list of technical skills pertains to specific industries and are not cross-disciplinary in nature.
